(19) United States
(12) Patent Application Publication
(10) Pub. No.: US 2026/0106095 A1
(43) Pub. Date: Apr. 16, 2026

(54) WALL SWITCH CONVERSION MECHANISM

(71) Applicants: Timothy Todd Griffin, Cookeville, TN (US); Weston Johnson, Cookeville, TN (US)

(72) Inventors: Timothy Todd Griffin, Cookeville, TN (US); Weston Johnson, Cookeville, TN (US)

(21) Appl. No.: 19/357,691

(22) Filed: Oct. 14, 2025

Related U.S. Application Data
(60) Provisional application No. 63/706,902, filed on Oct. 14, 2024.

(51) Int. Cl. H01H 21/30

(52) U.S. Cl. CPC H01H 21/30

(57) ABSTRACT

A wall switch conversion module, including a base mount having a first side configured to be removably attachable to a wall plate of a first switch, and a movement mechanism connected to a second side of the base mount opposite the first side, the movement mechanism including componentry configured to transfer actuation motion of a second switch such that transferred actuation motion of the second switch actuates the first switch.

### CROSS-REFERENCE TO RELATED APPLICATIONS

This application claims the benefit of U.S. Provisional Application No. 63/706,902 filed on Oct. 14, 2024, the contents of which are hereby incorporated by reference herein in their entirety.

### BACKGROUND

Example embodiments of the present general inventive concept relate to wall-mounted light switches commonly found in many homes and buildings.

Homeowners or other electrical installers may seek to address aesthetic issues with a preference for rocker style light switches over traditional toggle style flip-switches. However, it has been challenging for users to change from one type of light switch type to another due to complexities associated with electrical wiring, such as rewiring of power, neutral, and ground wires to the switch, and it has been important to have a certain level of knowledge and skill to perform the job safely. Knowledge, tools, and skills to uninstall traditional switching mechanisms, unwire the device, wire in the new switch, and reinstall into the box, was typically needed, and many users may simply desire not to invest the time and effort to complete these tasks, but would desire to change the appearance of the switches in their home or building to a more user-friendly and appealing form.

### BRIEF SUMMARY

Example embodiments of the present general inventive concept can be achieved by a wall switch conversion module, including a base mount having a first side configured to be removably attachable to a wall plate of a first switch, and a movement mechanism connected to a second side of the base mount opposite the first side, the movement mechanism including componentry configured to transfer actuation motion of a second switch such that transferred actuation motion of the second switch actuates the first switch.

In some embodiments, the module can include a cover member removably attachable to the base mount, the cover member being configured to enclose the movement mechanism within an interior space of the cover member.

In some embodiments, the first switch can be a toggle-type switch and the second switch can be a rocker-type switch.

In some embodiments, the componentry can include movement means including a first lower linkage having a first end pivotally connected to the second side of the base mount and a second end pivotally connected to a first end of the cam linkage such that actuation of the rocker-type switch drives movement of the first lower linkage and cooperating cam-linkage to actuate the toggle-type switch when the rocker-type switch is actuated by a user.

In some embodiments, the componentry can include a second lower linkage having a first end pivotally connected to the second side of the base mount and a second end pivotally connected to a second end of the cam linkage such that actuation of the rocker-type switch drives movement of the first lower linkage, second lower linkage, and cam-linkage to actuate the toggle-type switch when the rocker-type switch is actuated by a user.

In some embodiments, the cover member can include one or more snapping members configured to provide snapping removable attachment of the cover member to the base mount.

Additional features and embodiments of the present general inventive concept will be apparent to those of ordinary skill in the art upon review of the present application.

### BRIEF DESCRIPTION OF THE FIGURES

The following example embodiments are representative of example techniques and structures designed to carry out the present general inventive concept, but the present general inventive concept is not limited to these example embodiments. In the accompanying figures, the sizes and relative sizes, shapes, and qualities of lines, entities, and regions may be exaggerated for clarity. Additional features and embodiments of the present general inventive concept will be readily described and illustrated with reference to the accompanying figures, in which:

FIG. 1 illustrates an external perspective view of an example embodiment of the present general inventive concept;

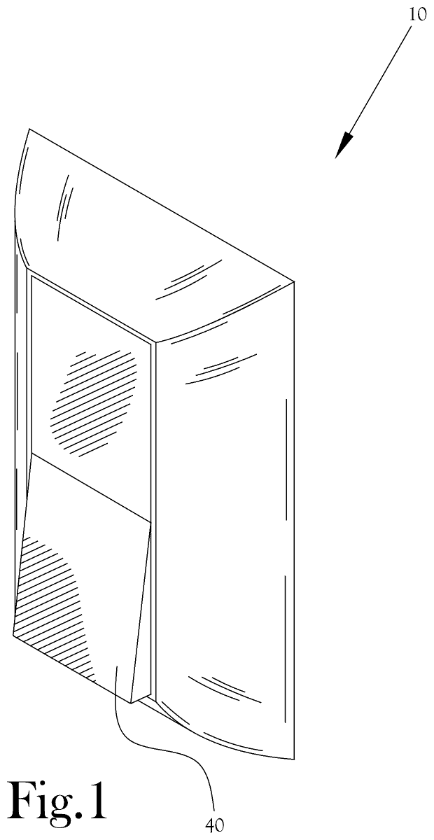

FIGS. 2A and 2B illustrate exploded internal perspective views of movement mechanism componentry configured according to an example embodiment of the present general inventive concept;

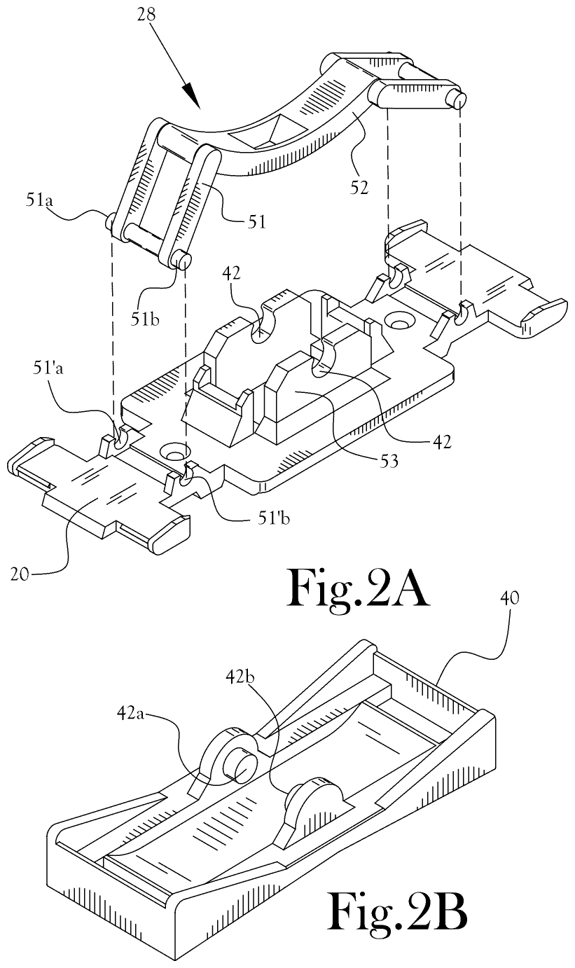

FIG. 3 illustrates a partial exploded assembly view of the movement mechanism componentry of FIG. 2 configured for installation to an existing toggle-type switch box wall plate;

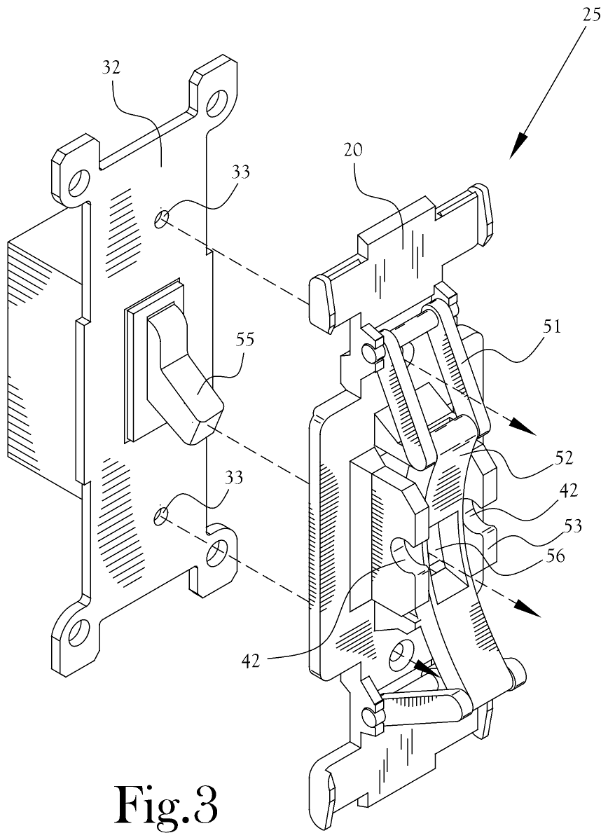

FIG. 4 illustrates an assembly view of a rocker-type paddle member configured for snapping attachment to a carriage portion of a base mount with a cover member configured for snapping attachment to a base mount according to an example embodiment of the present general inventive concept; and

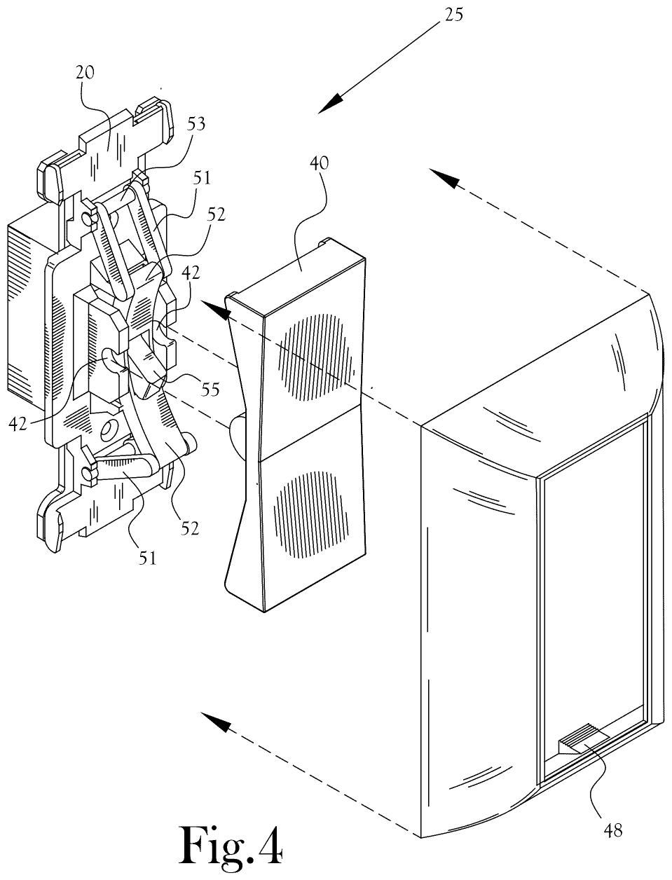

FIGS. 5A and 5B illustrate a sectional view of an example embodiment of the present general inventive concept.

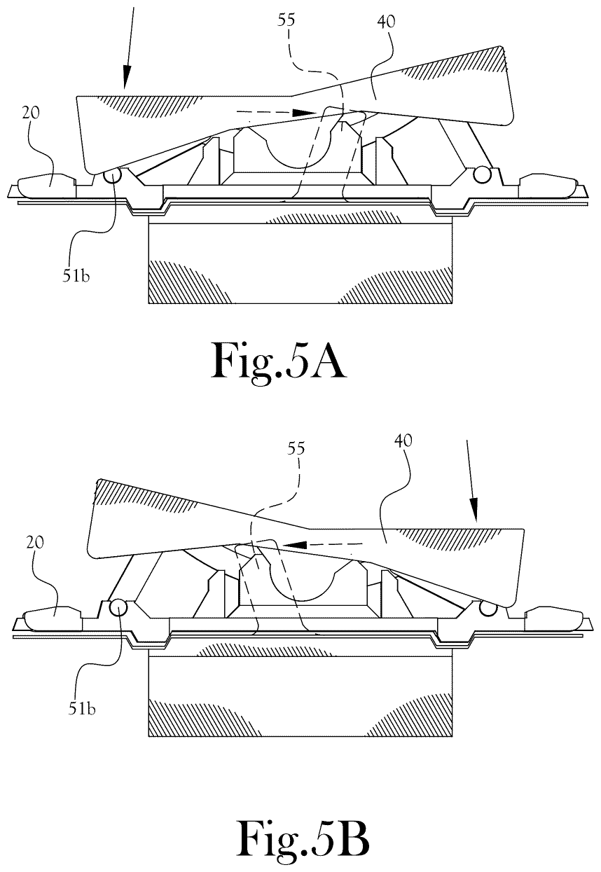

### DETAILED DESCRIPTION

Example embodiments of the present general inventive concept are described more fully hereinafter with reference to the accompanying drawings, which form a part hereof, and which show, by way of illustration, exemplary embodiments by which the invention may be practiced. The invention may, however, be embodied in many different forms and should not be construed as limited to the embodiments set forth herein; rather, these embodiments are provided so that this disclosure will convey the scope of the invention to those skilled in the art. The example embodiments are not intended to be entirely comprehensive or limited to the embodiments described herein or depicted in the drawings, and various additional embodiments, combinations of embodiments, and/or design modifications can be made using sound engineering judgement without departing from the scope of the claims presented.

Example embodiments of the present general inventive concept can be achieved using mechanical and structural componentry configured to perform the conversion of a toggle switch to rocker switch as illustrated in the accompanying images.

As described and illustrated in the figures and images attached hereto, example embodiments of the present general inventive concept can be directed generally to systems and methods of activating light switches, and more particularly to systems and methods of converting activation motion of a first light switch to activation motion of a second light switch mechanism without electrical re-wiring, enabling a homeowner to transform a first light switch mechanism into a second light switch mechanism via installation to an existing wall plate without having to modify existing electrical wiring of the light switch. Some embodiments include a pair of lower linkages and upper cam linkage configured to form a cam driver movement mechanism configured to effectuate transfer of rocker-style motion sufficient to actuate toggle switch 55 by pressing (actuating) an end of rocker paddle switch 40. A method of converting a toggle switch to a rocker switch without removal or rewiring of the toggle switch is thus provided.

Some embodiments of the present general inventive concept can be achieved by provision of a wall switch module 10 configured to be installed to an existing wall plate of a toggle-type switch 55, wherein the module assembly can be configured with a movement mechanism embodying mechanical and structural componentry designed for ease of attachment and for transfer of rocker-type pressing of a rocker/paddle-type switch 40 configured for pivotal, snap connection to a mounting member, such as carriage mount 53 configured to enable physical switching of a conventional toggle-type switch 55 between on/off by activation motion of a rocker-type paddle switch 40 transferred to linkages, such as lower linkages 51 and adjoining cam linkage 52 forming means for carrying out movement mechanism enclosed under cover housing 10, cover housing being configured with means for forming a snap fit between perimeter of housing 10 and perimeter of base mount 20 for attachment to switch box plate 32 via holes 33, without requiring the homeowner or user to modify electrical wiring or connections, as embodiments of the present general inventive concept enable quick-change of light switch to effectuate transition from a conventional toggle-type switch to a rocker-switch by installing the wall switch housing module to an existing wall-plate.

In some embodiments, a wall switch conversion mechanism is provided, including a cover member 10, rocker paddle member 40, base mount 20 for mounting a movement mechanism 25 apparatus to an existing switch box plate 32. The rocker paddle member 40 can attach to snap receiver 42 to enable snap fit for cam driver 28 to carriage mount 53 of base mount 20. The cam driver 28 can include linkage members, for example as embodied as lower linkages 51 and cam linkages 52 to effectuate the transfer of motion from rocker paddle to toggle switch, as illustrated in the figures.

In some embodiments, lower linkages can be configured to move up and down as the rocker paddle 40 is rocked from one position (on) to another position (off). Some figures and images depict linkages 51, 52 of a movement mechanism including the various componentry and structure configured to provide for a toggle switch clearance hole 56 in the cam linkage 52, including mounting holes, cutouts, rocker mounts, stops, extensions, cutouts, levers, adapters configured to transfer motion to actuate a toggle switch 55 when a rocker paddle switch 40 is actuated or pressed from one position to another, the rocking motion of the paddle 40 can be transferred to the lower linkages 51 and upper or cam linkages 52 causing the linkages to move in a see-saw fashion from one position to another, thereby enabling the opening 56 of the cam linkage 52 to drive the toggle switch 55 from a first position to a second position.

Referring to the attached figures, the linkage mechanisms shown can include multiple linkages 51, such for example three linkages illustrated herein, comprising two (2) lower linkages 51 and one cam linkage 52, although it is understood that more or less linkages and/or movement mechanisms could be implemented using sound engineering judgement without departing from the broader scope of the present general inventive concept. The rocker paddle switch 40 can be snap-mounted to the movement mechanism via carriage mount 53. As illustrated herein, linkages can be configured to transfer rotational activation motion of an exemplary paddle switch into linear motion to move the toggle mechanism back and forth.

A base wall mount 20 (see attached images and figures) can be configured to screw directly into an existing wall-switch plate, and the cover housing portion of the module can be configured to be installed to an edge of the base mount of the module wherein the cover housing can be configured to be installed to the base mount using a friction and/or snap fit to the base mount, for example embodying a snap fit between perimeter edges of base mount 20 and one or more snap members 48 around a perimeter edge of the base mount to provide a finished appearance of the cover member enclosing the movement mechanism componentry. Without limitation, the movement mechanism componentry can comprise means for forming one or more cam linkages 52 pivotally connected to lower linkages 51 to carry out actuation of toggle switch when user presses rocker paddle to actuate transfer of motion from paddle switch to cam driver assembly.

Example embodiments of the present general inventive concept can also be achieved by providing a method for operating a toggle light switch, as commonly found in many homes and buildings, using a rocker type switch, without the need for removal and rewiring of the original switch device. The movement mechanism can comprise a cam driver design configured to reciprocally flip a toggle-switch mechanism 55 between on/off by pressing the associated paddle area of rocker switch 40.

Some embodiments provide a wall switch conversion module, including a base mount configured to be removably attachable to a wall switch plate, and a movement mechanism connectable to the base plate, the movement mechanism including componentry configured to transfer actuation motion of a first switch such that movement of the first switch actuates a second light switch without modifying electrical wiring connections of the second light switch.

In some embodiments, a first light switch can be a rocker switch, and a second light switch can be a toggle switch., where example embodiments provide a means for converting a toggle switch to a rocker switch without removal or rewiring of the toggle switch. Example embodiments of the present general inventive concept and include any one or combination of components or operations described and/or illustrated herein, including equivalents thereof.

Example embodiments of the present general inventive concept can be achieved without interaction with electrical wiring in of the existing switch box, or with circuit breaker(s) providing power to the switch, and securely attaching the module to the existing toggle wall switch using the screw holes originally designed to secure the cover plate of the existing toggle switch.

Example embodiments of the present general inventive concept relate to modifying the appearance of a wall switch for users who prefer the rocker paddle or flush-mounted pushbutton style switches, and to attachment devices configured to securely attach module components (e.g., housing) over the top of an existing traditional toggle style switch without removal of the original switch from the box in the wall.

Example embodiments of the present general inventive concept can also be achieved by the provision of a reliable actuation means, including componentry designed to provide movement mechanism means within the cover housing conversion module to be installed on an existing wall plate (e.g., conversion module base and attachable housing member, to provide reliable actuation, by way of user input of the original toggle switch mechanism for turning the connected device on or off.

Those skilled in the art will appreciate that various modifications of the illustrated embodiments and components could be made to perform the same or similar functions in substantially the same way to achieve substantially the same results using sound engineering judgement. Such modifications and/or equivalent configurations are considered to fall within the scope of the present general inventive concept.

Certain implementations of the disclosed technology are described herein with reference to block diagrams of system features are made to aid the understanding of the novel configurations, functions, structures, or methods of the present general inventive concept, not to limit the scope of the present general inventive concept.

Example embodiments of the present general inventive concept can be achieved by a wall switch conversion module, including a base mount configured to be removably attachable to a wall switch plate of a first actuation switch, and a movement mechanism connected to the base mount, the movement mechanism including componentry configured to transfer actuation motion of a second actuation switch to actuate the first actuation switch.

In some embodiments, the first actuation switch is a toggle-type switch and the second actuation switch is a rocker-type switch, wherein the componentry includes a pair of lower linkages connected to mating snap-on receiving members of the base mount and at least one cam linkage disposed between the lower linkages such that actuation of the rocker-type switch connected to the carriage drives engagement movement of lower linkages and associated cam-linkage to drive actuation motion of the toggle-type switch when the rocker paddle switch is actuated by a user.

In some embodiments, the cover member can include one or more snapping members configured to provide snapping removable attachment of the cover member to one or more perimeter portions of the base mount.

Those skilled in the art will appreciate that various modifications to the example componentry illustrated herein to carry out the movements in response to switching forces applied by a user to actuate a first light switch and translate the actuation motion to a movement mechanism provided to the module, including the use of an articulated cam driver actuated by rocker or paddle shaped pieces, to switch a device on or off.

Those skilled in the art will appreciate that the claimed subject matter may be embodied in a variety of ways using sound engineering judgement and/or knowledge in the field, may include different elements or steps, and may be used in conjunction with other existing or future technologies. This description should therefore not be interpreted as implying any particular order or arrangement among or between various steps or elements except when the order of individual steps or arrangement of elements is explicitly described.

Referring to the figures, one or more of the illustrated features, mechanisms, functions, components, or structures described or illustrated herein, can be carried out separately or in combination to achieve embodiments of the present general inventive concept including any combinations, arrangements, or sub-combinations of the features, mechanisms, functions, components, or structures, including equivalents thereof.

As illustrated and described herein, example embodiments of the present general inventive concept can be achieved by a wall switch conversion module, including a base mount having a first side configured to be removably attachable to a wall plate of a first switch, and a movement mechanism connected to a second side of the base mount opposite the first side, the movement mechanism including componentry configured to transfer actuation motion of a second switch such that transferred actuation motion of the second switch actuates the first switch.

In some embodiments, the module can include a cover member removably attachable to the base mount, the cover member being configured to enclose the movement mechanism within an interior space of the cover member.

In some embodiments, the first switch can be a toggle-type switch and the second switch can be a rocker-type switch.

In some embodiments, the componentry can include movement means including a first lower linkage having a first end pivotally connected to the second side of the base mount and a second end pivotally connected to a first end of the cam linkage such that actuation of the rocker-type switch drives movement of the first lower linkage and cooperating cam-linkage to actuate the toggle-type switch when the rocker-type switch is actuated by a user.

In some embodiments, the componentry can include a second lower linkage having a first end pivotally connected to the second side of the base mount and a second end pivotally connected to a second end of the cam linkage such that actuation of the rocker-type switch drives movement of the first lower linkage, second lower linkage, and cam-linkage to actuate the toggle-type switch when the rocker-type switch is actuated by a user.

In some embodiments, the cover member can include one or more snapping members configured to provide snapping removable attachment of the cover member to the base mount.

It is to be noted that terms such as “example embodiments of the present general inventive concept” or “invention” are intended to refer broadly to all the subject matter described in this document and to the claims. Statements containing these terms should be understood not to limit the subject matter described herein or to limit the meaning or scope of the claims.

The systems and methods can include any one or combination of components or operations described and/or illustrated herein, including equivalents thereof.

It is understood that numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

This written description uses examples to disclose certain implementations of the disclosed technology, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

What is claimed is:

1. A wall switch conversion module, comprising:
a base mount having a first side configured to be removably attachable to a wall plate of a first switch; and
a movement mechanism connected to a second side of the base mount opposite the first side, the movement mechanism including componentry configured to transfer actuation motion of a second switch such that transferred actuation motion of the second switch actuates the first switch.

2. The module of claim 1, further comprising a cover member removably attachable to the base mount, the cover member being configured to enclose the movement mechanism within an interior space of the cover member.

3. The module of claim 2, wherein the first switch is a toggle-type switch and the second switch is a rocker-type switch, and wherein the componentry includes a first lower linkage having a first end pivotally connected to the second side of the base mount and a second end pivotally connected to a first end of the cam linkage such that actuation of the rocker-type switch drives movement of the first lower linkage and cooperating cam-linkage to actuate the toggle-type switch when the rocker-type switch is actuated by a user.

4. The module of claim 3, wherein the componentry includes a second lower linkage having a first end pivotally connected to the second side of the base mount and a second end pivotally connected to a second end of the cam linkage such that actuation of the rocker-type switch drives movement of the first lower linkage, second lower linkage, and cam-linkage to actuate the toggle-type switch when the rocker-type switch is actuated by a user.

5. The module of claim 2, wherein the cover member includes one or more snapping members configured to provide snapping removable attachment of the cover member to the base mount.
